(19) United States
(12) Patent Application Publication
(10) Pub. No.: US 2015/0068406 A1
(43) Pub. Date: Mar. 12, 2015

(54) WINE AERATOR

(71) Applicant: HELEN OF TROY LIMITED, Belleville (BB)

(72) Inventors: Douglas A. Marsden, Marblehead, MA (US); Benjamin J. Beck, Boston, MA (US); Elizabeth K. Delfino, Somerville, MA (US); Michael T. McDuffee, Gloucester, MA (US)

(73) Assignee: HELEN OF TROY LIMITED, Belleville (BB)

(21) Appl. No.: 14/025,093

(22) Filed: Sep. 12, 2013

(51) Int. Cl. C12G 1/00; B01F 5/04

(52) U.S. Cl. CPC C12G 1/00; B01F 5/0425
USPC 99/323.1

(57) ABSTRACT

A wine aerator includes a spout, a deflector connected with the spout, and an upper spout element connected with the spout. The spout connects with the neck of a wine bottle, defines an upstream outlet passage terminating at an intermediate outlet opening, and includes an extension defining a lower downstream surface downstream from the intermediate outlet opening. The deflector connects with the spout and is spaced from the lower downstream surface and is aligned with the intermediate outlet opening to cover the intermediate outlet opening. The upper spout element connects with the spout and is offset from the lower downstream surface. The upper spout element at least partially defines an aeration opening downstream from the intermediate outlet opening and the deflector. The upper spout element is configured to at least partially direct wine toward a downstream outlet opening while air contacts the wine through the aeration opening.

### BACKGROUND

Oftentimes it is desirable to aerate red wine prior to drinking. One manner in which red wine is aerated is by pouring the wine from the wine bottle to a decanter prior to pouring into a drinker's glass. Other devices exist where the device is independent of the wine bottle and must be held over a wine glass so that wine is poured from the bottle through the device and into the wine glass.

There are other aeration devices configured to fit with the neck of a wine bottle. Many of these devices have complicated structures or moving components, which makes for a more complex device.

### SUMMARY

In view of the above, an example of an improved wine aerator includes a spout, a deflector connected with the spout, and an upper spout element connected with the spout. The spout is configured to connect with the neck of an associated wine bottle. The spout defines an upstream outlet passage terminating at an intermediate outlet opening. The spout also includes an extension defining a lower downstream surface downstream from the intermediate outlet opening. The deflector connects with the spout and is spaced from the lower downstream surface. The deflector is aligned with the intermediate outlet opening to cover the intermediate outlet opening. The upper spout element connects with the spout and is offset from the lower downstream surface. The upper spout element at least partially defines an aeration opening downstream from the intermediate outlet opening and the deflector. The upper spout element is configured to at least partially direct wine toward a downstream outlet opening while air contacts the wine through the aeration opening.

Another example of a wine aerator includes a spout, a deflector connected with the spout, and an upper spout element connected with the spout. The spout is configured to connect with the neck of an associated wine bottle. The spout defines an upstream outlet passage terminating at an intermediate outlet opening. The spout also defines a wine aeration flow path downstream from the intermediate outlet opening. The upper spout element defines an upper boundary of the wine aeration flow path. The upper spout element at least partially defines an aeration opening downstream from the deflector. The upper spout element is configured to at least partially direct wine along the wine aeration flow path toward a downstream outlet opening while air contacts the wine through the aeration opening while wine is being poured through the wine aerator.

### BRIEF DESCRIPTION OF THE DRAWINGS

FIG. 1 is a perspective view of the wine aerator.

FIG. 2 is an exploded view of the wine aerator.

FIG. 3 is a cross-sectional view of the wine aerator.

FIG. 4 is another perspective view of the wine aerator in a position where wine is being poured from a wine bottle through the wine aerator.

### DETAILED DESCRIPTION

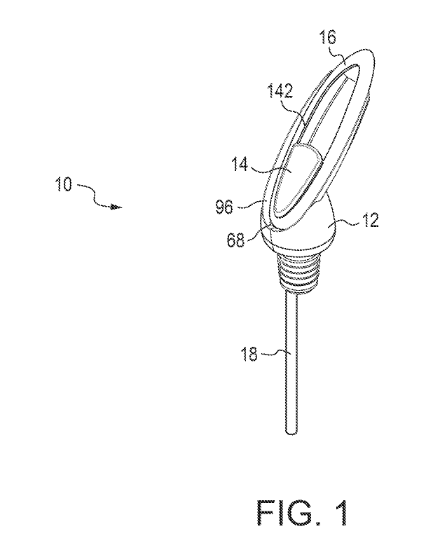

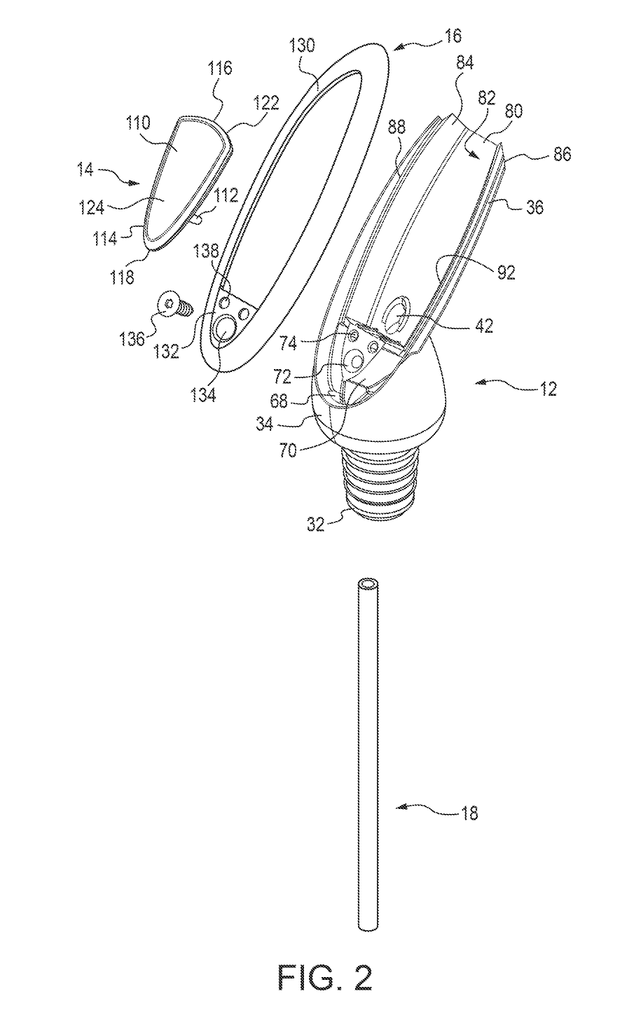

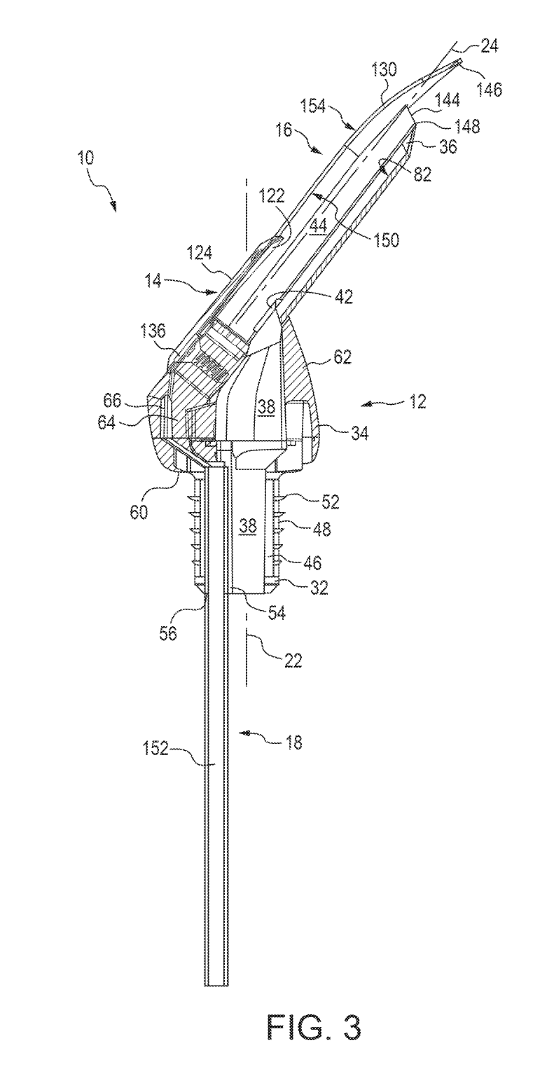

With reference to FIGS. 1 and 2, a wine aerator 10 generally includes a spout 12, a deflector 14, an upper spout element 16, and a straw 18. The spout 12 is configured to connect with the neck of a wine bottle. The deflector 14 connects with the spout 12 and redirects wine that contacts the deflector to aid in the aeration of the wine. The upper spout element 16 connects with the spout 12 and is configured to further direct the wine during the pouring and aeration process. The straw 18 allows air to enter into the wine bottle while wine is being poured from the bottle and the straw allows wine to reenter the bottle after pouring and after the wine bottle has been returned to an upright orientation. With reference to FIG. 3, the wine aerator 10 generally defines a first (vertical) axis 22 and a second (transverse) axis 24, which is transverse to the vertical axis 22.

The spout 12 includes a base section 32 that is inserted into the wine bottle, a mid-section 34 positioned above the base section 32, and an extension 36 extending from the mid-section 34 away from the base section 32. As seen in FIG. 3, the spout 12 defines an upstream outlet passage 38 through which wine travels when being poured from the wine bottle. The upstream outlet passage 38 terminates at an intermediate outlet opening 42. The spout 12 also defines a wine aeration flow path 44 downstream from the intermediate outlet opening 42.

The lower section 32 includes a cylindrical exterior wall 46 that is made from a rigid material such as plastic. The cylindrical exterior wall 46 has a diameter small enough so that the lower section 32 fits into the opening in the neck of a wine bottle. The outer diameter of the cylindrical exterior wall 46 is large enough so that a snug fit is provided between the cylindrical exterior wall 46 and the interior of the wine bottle. An overmold 48 is provided over the cylindrical exterior wall 46. The overmold 48 is a flexible material, e.g. silicone, to provide a seal between the wine bottle and the lower section 32 of the spout 12. Annular ribs 52 are formed on the overmold 48 to enhance the seal between the spout 12 and the neck of the wine bottle. The lower section 32 also includes a curved internal wall 54 that defines a passage 56 that receives the straw 18. The curved internal wall 54 separates the upstream outlet passage 38 from the passage 56 that receives the straw 18.

The lower section 32 transitions to the mid-section 34 at a shoulder 60, which is an external surface that is generally normal to the vertical axis 22. The spout 12 is pressed into the wine bottle opening until the top of the wine bottle is pressed against the shoulder 60. The mid-section 34 includes an outer side wall 62 that is generally cylindrical. The mid-section 34 is also made from a rigid material such as plastic. As seen in FIG. 3, the mid-section 34 also includes an internal wall 64 that separates the upstream outlet passage 38 from an air inlet passage 66 formed in the spout 12. The air inlet passage 66 opens to ambient at an air inlet opening 68.

As more clearly seen in FIG. 2, the mid-section 34 also includes a pedestal 70. A fastener opening 72 is provided in the pedestal 70. The fastener opening 72 can be threaded. The fastener opening 72 allows for the connection of the upper spout element 16 to the spout 12. Peg openings 74 are provided in the pedestal 70. The peg openings 74 are located above the fastener openings 72. The peg openings 74 allow for attachment of the deflector 14 and the upper spout element 16 to the spout 12.

The extension 36 includes a lower wall 80 that defines a lower downstream surface 82, which is substantially planar in the illustrated embodiment. The lower downstream surface 82 defines a lower boundary of the wine aeration flow path 44. The extension 36 also includes a left side wall 84 and a right side wall 86 that define sides of the wine aeration flow path 44. Each side wall 84, 86 extends from a respective edge of the lower wall 80 toward the upper spout element 16. Each side wall 84, 86 is angled away from the transverse axis 22, which is a central axis of the extension 36. The left side wall 84 defines a left shelf 88 and the right side wall 86 defines a right shelf 92. The upper spout element 16 rests on the shelves 88, 92.

With reference to FIG. 1, the spout 12 also includes a ledge 96. The ledge 96 extends in the same general direction as the side walls 84, 86 of the extension 36. The ledge 96 extends upwardly from the shelves 88, 92 and generally follows the curvature of the periphery of the upper spout element 16. The ledge 96 extends above the upper spout element 16. The ledge 96 in cooperation with the upper spout element 16 can redirect wine back into the wine bottle through the air inlet opening 68 and the straw 18.

The deflector 14 connects with the spout upstream from the wine aeration flow path 44. The deflector 14 includes a substantially thin flat element 110 having posts 112 (only one visible in FIG. 2) that are received in the post openings 74 provided in the pedestal 70 at the mid-section 34 of the spout 12. The flat element 110 making up the deflector 14 is of generally truncated oval shape having a narrower parabolic edge 114 and a wider parabolic edge 116. The vertex 118 of the narrower parabolic edge 114 is positioned adjacent the air inlet opening 68. The deflector 14 extends over the intermediate outlet opening 42 so that the deflector 14 is aligned with the intermediate outlet opening 42 to cover the intermediate outlet opening such that wine exiting the intermediate outlet opening while being poured from the wine bottle contacts the deflector. With reference to FIG. 3, the deflector 14 includes a lower (contact) surface 122 and an upper surface 124. The contact surface 122 is shaped to disperse the wine that contacts the deflector 14 into a fan-shaped stream. The contact surface 122 is generally planar while having a slight V-shaped curvature, which is centered along the transverse axis 24. As seen in FIG. 3, the deflector 14 is spaced from the lower downstream surface 82, which is the surface in which the intermediate outlet opening 42 is located.

As seen in FIG. 3, the upper spout element 16 connects with the spout 12 and is offset from the lower downstream surface 82. The upper spout element 16 defines an upper boundary of the wine aeration flow path 44. With respect to FIG. 2, the upper spout element 16 includes an oval ring-shaped section 130 and a substantially planar mounting section 132 that is internal of the oval ring-shaped section. The mounting section 132 includes a fastener opening 134 that is configured to receive a fastener 136. The fastener 136 is received in the fastener opening 134 in the planar mounting section 132 and the fastener opening 72 in the pedestal 70 to connect the upper spout element 16 to the spout 12. Peg openings 138 are also provided in the mounting section 132. The pegs 112 on the deflector 14 are received in the peg openings 138 in the mounting section 132 and the peg openings 74 in the pedestal 70 of the mid-section 34 of the spout 12.

The upper spout element 16 at least partially defines an aeration opening 142, which is downstream from the intermediate outlet opening 42 and the deflector 14. The aeration opening 142 is a substantially oval-shaped opening that is partially covered by the deflector 14. In the illustrated embodiment, the aeration opening 142 is surrounded by the upper spout element 16 and the deflector 14.

The upper spout element 16 is configured to direct wine that has fanned out due to contact with the deflector 14 and direct the fanned-out stream of wine toward a downstream outlet opening 144 while wine is being poured through the wine aerator 10. The upper spout element 16 directs the wine toward the downstream outlet opening 144 while air contacts the wine through the aeration opening 142. As mentioned above, the extension 36 and the upper spout element 16 define the downstream outlet opening 144. The spout 12 and the upper spout element 16 are configured such that air enters through the downstream outlet opening 144 to contact a lower surface of the wine along the wine aeration flow path 44 while wine is being poured through the wine aerator 10.

The oval-shaped ring section 130 includes a distal end 146 of the upper spout element 16. The distal end 146 of the upper spout element 16 is disposed downstream from the furthest edge 148 of the extension 36. The oval ring-shaped section 130 of the upper spout element 16 tapers toward the lower wall 80 of the extension 36 adjacent the distal edge 146 of the upper spout element. The distal end 146 of the oval ring-shaped section 130 is nearly coplanar with the lower downstream surface 82 of the extension 36.

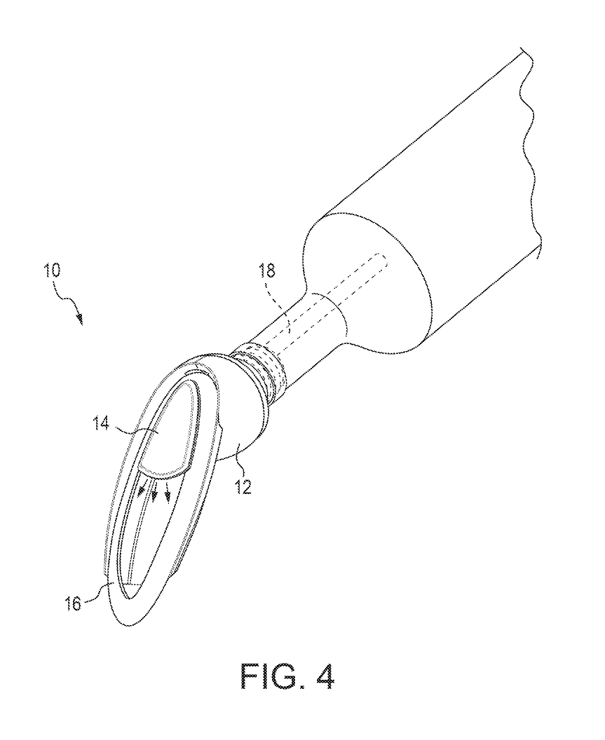

In use, a person inserts the lower section 32 of the spout 12 into the opening in the neck of a wine bottle. The wine bottle is then tipped to pour wine from the bottle, which places the wine aerator 10 is in the orientation shown in FIG. 4. Wine passes through the upstream outlet passage 38 in the spout 12 and is discharged from the upstream outlet passage at the intermediate outlet opening 42. The wine leaving the intermediate outlet opening 42 then contacts the contact surface 122 of the deflector 14. Upon contacting the contact surface 122 of the deflector 14, the stream of wine changes into a fan-shaped stream as designated by the arrows in FIG. 4, and flows along the wine aeration flow path 44. The wine in the fan-shaped stream rides along a lower surface 150 of the oval ring-shaped section 130 of the upper spout element 16. Due to surface tension in the fan-shaped stream of wine along the wine aeration flow path 44 and the oval shape of the oval-shaped section 130, a thin stream of wine spans between opposite sections (on opposite sides of the lateral axis 24) of the oval-shaped section and spans across the aeration opening 142. As such, air can contact this upper surface of the fan-shaped stream. Moreover, since the contact surface 122 of the deflector 14 and the lower surface 150 of the oval ring-shaped section 130 are both spaced from the lower downstream surface 82 of the extension, air can enter through the downstream outlet opening 144 and contact a lower surface of the fan-shaped stream of wine to aerate an undersurface of the wine stream as well. The tapering of the oval ring-shaped section 130 toward the lower wall 80 of the extension 36 directs the wine downwardly into an awaiting wine glass.

While wine is being poured, air enters through the air inlet opening 68 in the spout 12. The air travels through the air inlet passage 66 in the spout 12, which is connected with an internal passage 152 of the straw 18. The air inlet 68 allows for faster pouring of the wine from the bottle without “glugging.” When the wine bottle is returned to its upright configuration so that the wine aerator is positioned as shown in FIG. 1, any wine found on an upper surface 154 of the upper spout element 16 is directed back into the bottle. Any wine on the upper surface of the upper spout element 16 contacts the ledge 96 and is directed toward the air inlet opening 68 and back through the straw 18 into the wine bottle.

The wine aerator has been described above with particularity. Modifications and alterations will occur to those upon reading and understanding the preceding detailed description. The invention, however, is not limited to only the embodiment described above. Instead, the invention is broadly defined by the appended claims and the equivalents thereof. It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A wine aerator comprising:
a spout configured to connect with the neck of an associated wine bottle and defining an upstream outlet passage terminating at an intermediate outlet opening, the spout including an extension defining a lower downstream surface downstream from the intermediate outlet opening;
a deflector connected with the spout and spaced from the lower downstream surface, the deflector being aligned with the intermediate outlet opening to cover the intermediate outlet opening; and
an upper spout element connected with the spout and offset from the lower downstream surface, the upper spout element at least partially defining an aeration opening downstream from the intermediate outlet opening and the deflector, wherein the upper spout element is configured to at least partially direct wine toward a downstream outlet opening while air contacts the wine through the aeration opening.

2. The wine aerator of claim 1, wherein the deflector includes a contact surface shaped to disperse the wine that contacts the deflector into a fan-shaped stream.

3. The wine aerator of claim 2, wherein the contact surface is generally planar while having a slight V-shaped curvature.

4. The wine aerator of claim 1, wherein the upper spout element includes an oval ring-shaped section.

5. The wine aerator of claim 4, wherein the aeration opening is an oval-shaped opening partially covered by the deflector.

6. The wine aerator of claim 1, wherein the spout includes a base section that is inserted into the associated wine bottle, a mid-section above the base section and an extension extending from the mid-section away from the base section.

7. The wine aerator of claim 6, wherein the extension includes a lower wall that defines the lower downstream surface.

8. The wine aerator of claim 7, wherein the extension includes a left side wall and a right side wall, each side wall extends toward the upper spout element, and each side wall defines a shelf on which the upper spout element rests.

9. The wine aerator of claim 8, wherein a distal end of the upper spout element is disposed downstream from a furthest edge of the extension.

10. The wine aerator of claim 9, wherein the upper spout element tapers toward the lower wall of the extension adjacent the distal edge.

11. The wine aerator of claim 8, wherein each side wall is angled away from a central axis of the extension.

12. The wine aerator of claim 6, wherein the lower downstream surface is substantially planar.

13. The wine aerator of claim 1, further comprising an air inlet straw, wherein the spout defines an air inlet passage and the air inlet straw is in communication with the air inlet passage.

14. The wine aerator of claim 13, wherein the spout defines an air inlet opening in communication with the air inlet passage, wherein the spout further includes a ledge that cooperates with the upper spout element to direct wine on an upper surface of the upper spout element toward the air inlet passage when the wine aerator is in the upright position.

15. A wine aerator comprising:
a spout configured to connect with the neck of an associated wine bottle and defining an upstream outlet passage terminating at an intermediate outlet opening, the spout defining a wine aeration flow path downstream from the intermediate outlet opening;
a deflector connected with the spout upstream from the wine aeration flow path; and
an upper spout element connected with the spout and defining an upper boundary of the wine aeration flow path, the upper spout element at least partially defining an aeration opening downstream from the deflector, wherein the upper spout element is configured to at least partially direct wine along the wine aeration flow path toward a downstream outlet opening while air contacts the wine through the aeration opening while wine is being poured through the wine aerator.

16. The wine aerator of claim 15, wherein the aeration opening is surrounded by at least one of the deflector and the upper spout element.

17. The wine aerator of claim 15, wherein the spout includes a base section that is inserted into the associated wine bottle, a mid-section above the base section and an extension extending from the mid-section away from the base section, wherein the extension includes a lower wall that defines a lower downstream surface, which is offset from the upper spout element.

18. The wine aerator of claim 17, wherein the extension and the upper spout element define the downstream outlet opening, wherein the spout and the upper spout element are configured such that air enters through the downstream outlet opening to contact a lower surface of the wine along the wine aeration flow path while wine is being poured through the wine aerator.
